(19) United States
(12) Patent Application Publication
(10) Pub. No.: US 2013/0052873 A1
(43) Pub. Date: Feb. 28, 2013

(54) BACKWARD COMPATIBLE CONTACTLESS SOCKET CONNECTOR, AND BACKWARD COMPATIBLE CONTACTLESS SOCKET CONNECTOR SYSTEM

(71) Applicants: Dirk-Jan RIEZEBOS, Elst (NL); Peter Dirk JAEGER, Dussen (NL); Wijnand VAN GILS, Raamsdonksveer (NL); Jan BROEKSTEEG, Oss (NL)

(72) Inventors: Dirk-Jan RIEZEBOS, Elst (NL); Peter Dirk JAEGER, Dussen (NL); Wijnand VAN GILS, Raamsdonksveer (NL); Jan BROEKSTEEG, Oss (NL)

(73) Assignee: TYCO ELECTRONICS NEDERLAND BV, AR S-Herogenbosch (NL)

(21) Appl. No.: 13/592,205

(22) Filed: Aug. 22, 2012

(30) Foreign Application Priority Data
Aug. 23, 2011 (EP) 11006882

(51) Int. Cl. H01R 13/719

(52) U.S. Cl. 439/620.21

(57) ABSTRACT

The invention relates to socket connectors and socket connector systems for electrically connecting a first corresponding plug connector and for capacitively connecting a second corresponding plug connector. Further, the invention relates to a plug connector for capacitively connecting a corresponding socket connector. In order to allow for an electrical connection or a capacitive connection, the invention suggest providing a connecting element, arranged within the housing of the socket connector, including contact portion for contacting a connection area of the first plug connector, and a non-contact portion arranged such that, in the mated state, the surface thereof covers at least parts of a connection area of the second plug connector.

### FIELD OF THE DISCLOSURE

The invention relates to a socket connector for electrically connecting a first corresponding plug connector and for capacitively connecting a second corresponding plug connector. In particular, the invention provides a socket connector and socket connector system including at least one connecting element.

Generally, the invention relates to socket connectors for signal transmissions. A socket connector of the invention may, for instance, comply with known connection interface standards, for instance, Ethernet, USB, CAN, IO-link, RS485, DVI, HDMI, mini DISPLAYPORT, micro USB 3.0 MHL and Thunderbolt. In more detail, the socket connector of the invention may be utilized for portable data processing devices such as mobile phones, mobile storage units, mobile music players, mobile video presentation devices, namely for allowing connections under hostile environmental influences.

### BACKGROUND OF THE DISCLOSURE

Portable data processing devices have evolved in the past from stationary personal computers to mobile devices allowing for an indoor and outdoor usage. Due to the portability, mobile devices are carried around and are thereby exposed to hostile environmental influences, e.g. dust, dirt, humidity, rain, acid liquids, heat, cold, shock and mechanical stress. In this respect, the connectors (in particular, socket connectors) of a mobile device, positioned at the boundary between an outside and an inside of the mobile device, require adaptation to the newly diversified operating environments.

In the past, socket connectors were realized as electrical connectors wherein an electrical connection was established between the plug connector and a corresponding socket connector, i.e. female connector. However, electrical connections require a direct connection between two electrical contacts and the tolerance regarding misalignment between contacts is not very high. Dust, dirt, shock and mechanical stress may adversely effect the establishment of an electrical connection between plug connector and socket connector. Electrical connections are also sensitive to humidity e.g. rain. Specifically, water may short-circuit electrical contacts within the plug connector or the socket connector in an un-intended manner. Further, environmental influences may also deteriorate the contact surface reducing the conductivity of the electrical connection in a mated state.

Accordingly, electrical connectors, though reasonable for an indoor operating environment, are disadvantageous for portable devices operable under hostile environmental influences.

In this respect, alternative connection concepts have been suggested as a replacement of conventional electrical connector systems. For example, optical connectors are considered more tolerant against hostile environments; humidity, rain, acid liquids, heat, and cold do not affect the propagation of light.

However, a change to new connector concepts is difficult for existing product categories. Device manufacturers usually want to ensure compatibility with as many existing connectable products a possible.

For example, a conventional tip-ring-sleeve (TRS) plug connector, i.e. audio jack, has been utilized for decades in the product category of audio/video devices such as cassette players, portable CD players, and other media players. In the more recent past, the TRS connector has been upgraded as tip-ring-ring-sleeve (TRRS) plug connector to include a fourth connection area.

In particular, the TRRS connector is deployed in portable media players or mobile phones for realizing additional functionality without loosing compatibility with a conventional TRS plug connector. In TRRS connectors, conventional TRS plug connectors may be used without drawbacks. It may be considered a widely recognized fact that many accessories with a TRS plug connector exist in the market and that the TRRS connector ensures backward compatibility with these existing accessories.

Hence, backward compatibility appears an important feature in the development of a new connection concept for use as socket connector of a known product category.

### SUMMARY

A TRRS plug connector is exemplary shown in FIG. 5. The TRRS connector 5200 is illustrated in a mated state with socket connector 5100. In particular, the socket connector 5100 includes four electrical connecting elements 5120 which electrically connect to a respective of four connection areas 5210 of the TRRS connector 5200. An electrical connection is indicated as arrow between the socket connector 5100 and the respective connection area 5210 of the plug connector 5200.

The object underlying the invention is to propose a backward compatible socket connector, which reduces susceptibility to environmental influences while allowing for a small and cost-effective socket connector construction.

Another object of the invention is to suggest a backward compatible socket connector, which improves reliability and fail safety of the connection, namely which allows operation even with a considerable amount of misalignment between the socket connector and the plug connector in the mated state.

A further object of the invention is to suggest a plug connector which allows for a capacitive connection with a corresponding socket connector and is tolerant against hostile environmental influences.

A first aspect of the invention is the utilization of a connecting element (e.g. electrical connecting element) of a socket connector for a capacitive connection with a second type plug connector (e.g. capacitive type plug connector). In the socket connector, backward compatibility is attained by the connecting element electrically connecting a first type plug connector. An additional usage of the connecting element for a capacitive connection together with a second type plug connector dispenses with the need for additional transceiver modules in the socket connector. Consequently, a single connecting element which allows for an electrical connection and a capacitive connection, depending on the type of the plug connector, enables a cost-effective socket connector construction.

Furthermore, a capacitive connection has a low susceptibility to hostile environmental influence. Since the connecting element of the socket connector and the second type plug connector may be spaced at a predetermined distance, the capacitive coupling is more tolerant to dust, dirt, humidity, rain, acid liquids, heat, cold, shock or mechanical stress compared to an electrical connection. Optical and radio wave connections are also considered to be more tolerant to hostile environments than electrical connections. However, for an optical or a radio wave connection, dedicated transceiver module(s) are required in the plug connector as well as in the socket connector, thus requiring a larger housing to incorporate the electrical connecting element as well as the additional transceiver module(s).

In this respect, the socket connector utilizing—as in the first aspect of the invention—the same connecting element for an electrical connection as well as for a capacitive connection (depending on the type of the plug connector) is tolerant to hostile environments, minimizes space requirements of the socket connector and reduces the production costs thereof.

A second aspect of the invention is the adaptation of the shape of a connecting element (e.g. electrical connecting element) in a socket connector so that the connecting element also covers a substantial portion of a connection area of a plug connector.

For this purpose, the at least one connecting element of the socket connector may be structured as a contact portion and as a non-contact portion. The contact portion of the connecting element allows for backward compatibility, since, in the mated state with a first type plug connector, it electrically contacts a respective connection area of the first type plug connector. The non-contact portion may be considered superfluous with regard to providing an electrical connection between the socket connector and the first type plug connector.

However, in the mated state with a second type plug connector (capacitive type plug connector), the non-contact portion of the connecting element enables a capacitive coupling between the socket connector and the second type plug connector. The surface of the non-contact portion is arranged such that it at least partially overlies a connection area of the second type plug connector. Preferably, the surface of the non-contact portion is arranged circumferential to connection area of the plug connector with an equidistant spacing between the non-contact portion and the connection area.

For example, in case the connection area of the second type plug connector is provided in a ring shape, the surface of the non-contact portion of the connecting element of the socket connector is arranged preferably with a circular cross section so as to surround the connection area from the outside. Alternatively, in case the connection area of the second type plug connector is provided in a cubical shape, the surface of the non-contact portion of the connecting element is arranged preferably with a rectangular cross section so as to surround the connection area from the outside.

In general, the larger the surface of the non-contact portion of the connecting member which is covering, in the mated state, the connection area of the second type plug connect, the higher the capacitive coupling between the connection member and a connection area of a plug connector. Accordingly, with the surface of the non-contact portion of the connecting member covering, in the mated state, a substantial amount of connection area of the plug connector, the capacitive connection is tolerant to misalignment between the socket connector and the second type plug connector. For instance, in case the second type of plug connector is not completely inserted into the socket connector, the surface of the non-contact portion of the connecting element still mostly overlies a corresponding connection area so that the misalignment does not prevent from a capacitive connection between socket connector and second type plug connector.

Consequently, the socket connector, as in the second aspect of the invention, allows for backward compatibility and at the same time improves reliability and fail safety of the connection, namely enabling operation even with a considerable amount of misalignment between the socket connector and the plug connector in the mated state.

Furthermore, the structure of the non-contact portion of the connecting element, as in the second aspect of the invention, is also not suggested by a conventional socket connector. Conventional electrical connecting elements in a socket connector achieve three main goals, namely they provide for electrical connectivity, they guarantee for structural robustness of the contact, and they optimize material costs. All three goals contradict the structure of the non-contact portion of the contacting element according to the second aspect of the invention, namely of enlarging the surface of the non-contact portion of the connecting element so that it covers a substantial portion of a connection area of a plug connector. In particular, elongating the connecting element may result in a higher resistance. A longitudinal and/or lateral extension of a connecting element does also not contribute to a higher structural stability. Further, the added material increases costs for manufacturing the socket connector. Thus, an adaptation of the structure of the connecting element—according to the second aspect of the invention—would not be considered for conventional socket connectors.

A third aspect of the invention is the modification of a radial plug connector with conventional dimensions by covering its electrical connection areas with dielectric material so as to prevent, in the mated state with a corresponding socket connector, an electrical connection from establishing between the plug connector and the socket connector.

### SUMMARY

Radial plug connectors have proven to enable an easy mating with a corresponding socket connector. Specifically, radial plug connectors with a conventional shape have been widely accepted and can be cost-effectively manufactured. Nevertheless, conventional radial plug connectors are disadvantageous in hostile environments, since with outwardly exposed electrical connection areas, dust, dirt, shock and mechanical stress may adversely affect the establishment of an electrical connection between plug connector and corresponding socket connector.

In this respect, according to an exemplary embodiment of the invention, a radial plug connector with conventional dimensions is provided for capacitively connecting a corresponding mating socket connector, the plug connector comprising: at least one ring shaped connection area; a transmission and/or reception circuit connected to the at least one ring shaped connection area; wherein the outside of the connection area is entirely covered by dielectric material and the transmission and/or reception circuit is adapted to transmit and/or receive a modulated data signal via the connection area to/from the socket connector by capacitive coupling.

According to a more detailed embodiment, the radial plug connector of the embodiment has the dimensions of a conventional tip-ring-ring-sleeve (TRRS) plug connector, and the at least one connection area of the radial plug connector has approximately the same width of and the same spacing as respective connection area(s) of the conventional TRRS plug connector.

The first and second aspect of this invention can be readily combined with each other in a backward compatible socket connector as will become apparent from the detailed description.

According to an exemplary implementation of the invention, a socket connector for electrically connecting a first corresponding mating plug connector and for capacitively connecting a second corresponding mating plug connector is provided. The socket connector comprises a housing with a cavity for receiving either of the first and second plug connector; and at least one connecting element arranged within the housing, and including a contact portion for contacting a connection area of the first plug connector, and a non-contact portion arranged such that, in the mated state, the surface thereof covers at least parts of a connection area of the second plug connector.

According to a more detailed embodiment, the contact portion and the non-contact portion of the connecting element are provided of a same conductive material.

Due to the contact portion and the non-contact portion of the connecting element being realized of a same conductive material, the connecting element can be fabricated in a same fabrication step and the fabrication costs are reduced. Metal may be used for conductive material, namely steel or copper. Alternatively, as conductive material, a highly doped, conductive semiconductor material may be used.

In another more detailed embodiment, in the mated state, the surface of the non-contact portion, covering the connection area of the second plug connector, is provided at a predefined distance to the connection area of the second plug connector.

With a predefined distance between the non-contact portion of the connecting element and the surface of the connection area of the plug connector, the capacitive coupling improves. In particular, at a predefined distance, the covering area of the non-contact portion of the connecting element equally contributes to a capacitive coupling between the socket connector and the plug connector.

According to a further embodiment, the at least one connecting element is arranged within the housing so as to at least partially surround the cavity thereof.

For a ring shaped connection area, the connecting element may be provided so as to at least partially surround a corresponding connection area. Thereby, the connecting element may be provided so as to embrace the connection area or to enclose the connection area to improve the capacitive coupling between the socket connector and the plug connector.

According to another embodiment, the at least one connecting element is arranged within the housing so as to surround the cavity in a direction perpendicular to the longitudinal axis defined by the mating movement with the first or second plug connector.

Providing a connecting element which surrounds the cavity in a direction perpendicular to the longitudinal axis allows for the arrangement of plural connecting elements side by side. Plural connecting elements may be incorporated, wherein each of the connecting elements has a similar capacitive coupling value with a respective connection area of the plug connector. This geometrical arrangement of the connecting elements dispenses with the need for an equalizing step when receiving/transmitting different signals in parallel via plural connecting elements.

In a further more detailed embodiment, the socket connector further comprises: a dielectric material provided on the surface of the non-contact portion of the at least one connecting element so as to be arranged, in the mated state, between the non-contact portion of the connecting element and the connection area of the second plug connector.

A dielectric material provided in-between the non-contact portion of the connecting element and the connection area of the plug connector allows for increasing the capacitive coupling by utilizing a dielectric material with a high permittivity value. Further, the dielectric material may allow for an equidistant spacing between the plug connector and the non-contact portion of the connecting element of the socket connector.

In another more detailed embodiment, for a circular/rectangular/oval second plug connector, the at least one connecting element is arranged with a circular/rectangular/oval cross section.

By choosing a same cross section for the non-contact portion of the connecting element compared to that of the surface of the plug connector, the distance between the surface of the plug connector and the non-contact portion of the socket connector can be minimized contributing to a high capacitive coupling.

In a further more detailed embodiment, the socket connector further comprises a transmission and/or reception circuit connected to the at least one connecting element for transmitting and/or receiving data or power via an electrical connection, and for transmitting and/or receiving data via an capacitive connection to/from the mated first or second plug connector.

According to an embodiment, the socket connector further comprises: an antenna element provided within the rear wall portion of the housing so as to be arranged in the vicinity of a tip portion of a mated first or second plug connector, wherein the antenna element is connected to a transmission and/or reception circuit for receiving data via an electromagnetic connection from the respective first or second plug connector.

An antenna element allows for a second, parallel connection path enabling to further increase the data communication rate.

According to an alternative embodiment, the socket connector further comprises: a capacitive plate provided within the rear wall portion of the housing so as to be arranged in the vicinity of a tip portion of a mated first or second plug connector, wherein the capacitive plate is connected to a transmission and/or reception circuit for receiving data from the respective first or second plug connector.

A conductive plate allows for a second, parallel connection path enabling to further increase the data communication rate.

In another embodiment, a radio wave propagating element is provided within the rear wall portion of the housing so as to allow propagation of radio waves for an electromagnetic connection between an antenna element within the mated first or second plug connector and an antenna element provided behind the socket connector.

In case of a large sized antenna element and/or a high number of data input and data output terminals, integration within the socket connector would demand for a bulky socket connector dimensions. In this respect, it may be preferable to allow for a separate arrangement of the socket connector and the antenna element while the radio wave propagating element enables propagation of radio waves at low attenuation.

In a further embodiment, the socket connector further comprises: an inductive coupling element provided within the housing at a rim portion of the cavity; wherein the inductive coupling element is arranged so as to form in the mated state an induction loop with a corresponding inductive coupling element of a first or second plug connector.

With a bi-directional communication circuit and power transmission capabilities, the socket connector of this embodiment can be readily used with known connection interface standards, for instance, Ethernet, USB, CAN, IO-link, RS485, DVI, HDMI, mini DISPLAYPORT, micro USB 3.0 MHL and Thunderbolt.

According to another embodiment, the housing is adapted to receive a 3-pole tip-ring-sleeve (TRS) type first plug connector, and a first of the at least one connecting element is aligned with a lateral tip connection area of the first plug connector, a second of the at least one connecting element is aligned with a ring connection area of the first plug connector, and a third of the at least one connecting element is aligned with a sleeve connection area of the first plug connector.

According to a further embodiment, the housing is adapted to receive a 4-pole tip-ring-ring-sleeve (TRRS) type first plug connector, and a first of the at least one connecting element is aligned with a lateral tip connection area of the first plug connector, a second of the at least one connecting element is aligned with a ring connection area of the first plug connector, a third of the at least one connecting element is aligned with another ring connection area of the first plug connector, and a fourth of the at least one connecting element is aligned with a sleeve connection area of the first plug connector.

In a further more detailed embodiment, the housing is sealed against intrusion of water.

By embedding in a housing that is sealed against intrusion of water, the socket connector can be utilized under hostile environmental influences without putting the risk of short-circuiting the circuitry of the contactless plug connector.

In a further, more detailed embodiment, the housing of the socket connector is arranged to receive a radial first or second plug connector allowing the plug connector to rotate in a mated state.

As a radial connector, the contactless plug connector can be more easily applied to the corresponding mating connector.

According to another exemplary implementation of the invention, a socket connector system comprising: a socket connector and a corresponding 3-pole tip-ring-sleeve (TRS) type first plug connector or a corresponding 4-pole tip-ring-ring-sleeve (TRRS) type first plug connector is provided.

In another exemplary implementation of the invention, a socket connector system comprising: a socket connector and a corresponding second plug connector with at least one connection area covered on the outside with dielectric material is provided, wherein, in a mated state, a capacitive connection is made available between the at least one connecting element of the socket connector and the respective one of the at least one connection area of the corresponding second plug connector.

### BRIEF DESCRIPTION OF THE DRAWINGS

The accompanying drawings are incorporated into and form a part of the specification to illustrate several embodiments of the present invention. These drawings, together with a description, serve to explain the principles of the invention. The drawings are merely for the purpose of illustrating the preferred and alternative examples of how the invention can be made and used, and are not to be construed as limiting the invention to only the illustrated and described embodiments. Furthermore, several aspects of the embodiments may form—individually or in different combinations—solutions according to the present invention. Further features and advantages will be become apparent from the following more particular description of the various embodiments of the invention as illustrated in the accompanying drawings, in which like references refer to like elements, and wherein:

FIG. 1a schematically shows a socket connector in a mated state with a first type plug connector, the socket connector being in accordance with an exemplary embodiment of the invention;

FIG. 1b schematically shows a socket connector in a mated state with a second type plug connector, the socket connector being in accordance with an exemplary embodiment of the invention;

FIG. 2a schematically shows a socket connector in a mated state with a plug connector, the socket connector being in accordance with a second exemplary embodiment of the invention;

FIG. 2b schematically shows a socket connector in a mated state with a plug connector, the socket connector being in accordance with a second exemplary embodiment of the invention;

FIG. 3 schematically shows a socket connector in a mated state with a plug connector, the socket connector being in accordance with a third exemplary embodiment of the invention;

FIG. 4 schematically shows a cross-section of a socket connector in a mated state with a plug connector along the line A-A of FIG. 3, the socket connector being in accordance with the third embodiment of the invention; and

FIG. 5 schematically shows a socket connector in a mated state with a TRRS plug connector.

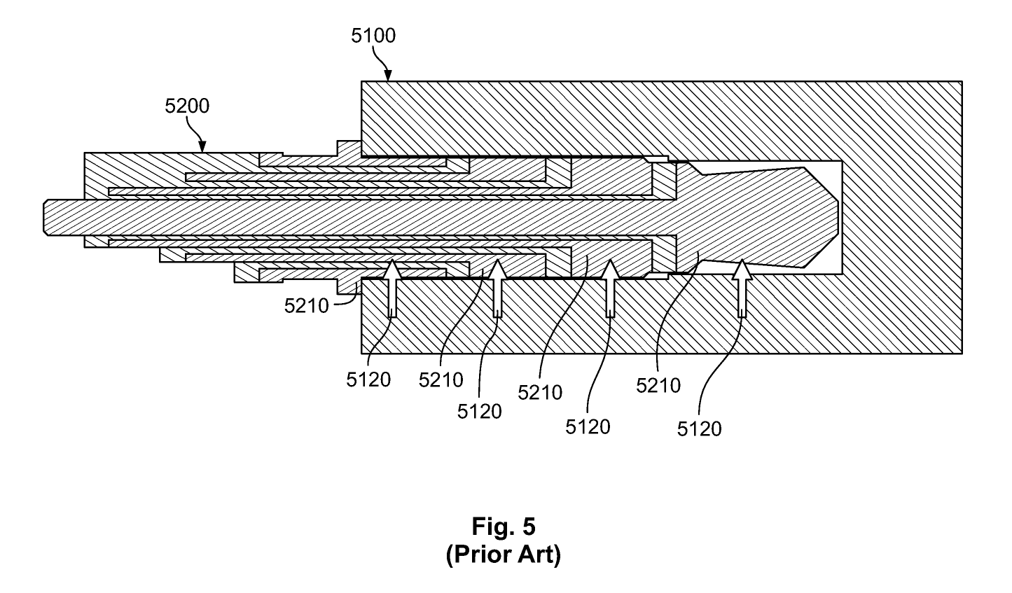

### DETAILED DESCRIPTION

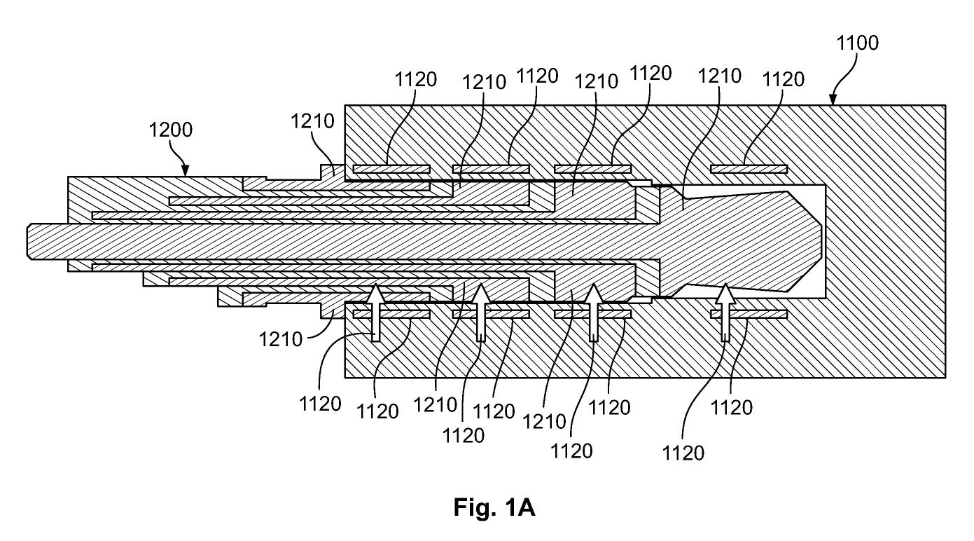

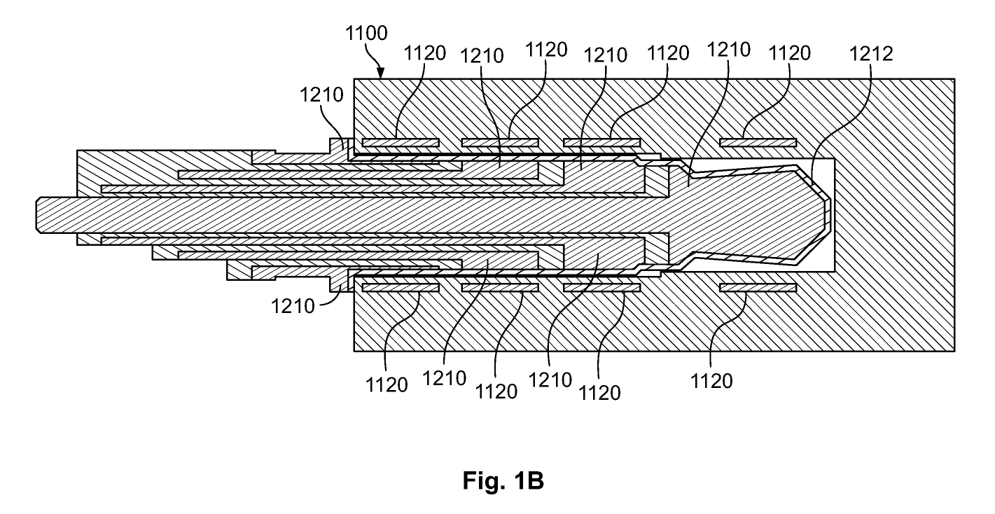

Referring to FIGS. 1a and 1b, a schematic diagram of a socket connector 1100 according to a first exemplary embodiment of the invention is shown. The socket connector 1100 of this first embodiment is shown in a mated state with either a corresponding first type plug connector 1200 as illustrated in FIG. 1a or a second type plug connector as illustrated in FIG. 1b.

The socket connector 1100 includes a housing with a cavity for receiving either of the first type or second type plug connector 1200. The socket connector 1100 of the first embodiment may be used for electrically connecting a first type plug connector 1200 or for capacitively connecting a second type plug connector. Accordingly, the socket connection 1100 enables utilization in devices where backward compatibility is necessary.

As shown in FIG. 1a, an exemplary first type plug connector may be a tip-ring-ring-sleeve (TRRS) type plug connector 1200. The TRRS type plug connectors 1200 is a round connector with four ring-shaped connection areas 1210 formed of a conductive material, for instance, metal. The connection areas 1210 are separated by dielectric material so as to enable four separate electrical connections between the TRRS type plug connector 1200 and a corresponding socket connector 1100.

The socket connector 1100 of the first embodiment includes at least one connecting element 1120 which is arranged in the housing of the socket connector 1100. The connecting element 1120 allows for an electrical connection between the socket connector 1100 and a corresponding first type plug connector 1200. In particular, a contact portion of the connecting element 1120 contacts, in the mated state, a corresponding connection area 1210 of the first type plug connector 1200.

An electrical connection between the contact portion of the connecting element 1120 of the socket connector 1100 and the first type plug connector 1200 is illustrated in FIG. 1 with an arrow pointing from the connecting element 1120 to the corresponding connection area 1210 of the first type plug connector 1200.

As shown in FIG. 1a, the exemplary socket connector 1100 of the first embodiment includes four connecting elements 1120. Each of the four connecting elements is aligned with a respective connection area 1210 of the first type plug connector 1200.

In particular, a first connecting element 1120 is arranged within the housing so as to contact, in the mated state, a lateral tip connection area 1210 of the first type plug connector 1200. A second connecting element 1120 is arranged within the housing so as to contact, in the mated state, a first ring connection area 1210 of the first type plug connector 1200. A third connecting element 1120 is arranged within the housing so as to contact, in the mated state, a second ring connection area 1210 of the first type plug connector 1200. A fourth connecting element 1120 is arranged within the housing so as to contact, in the mated state, a sleeve connection area 1210 of the first type plug connector 1200.

As shown in FIG. 1b, an exemplary second type plug connector may be a plug connector 1200 with an enclosure/outside made of dielectric material 1212, for instance, plastic. In particular, plug connector 1200 of FIG. 1b is shown with the mating portion entirely covered by dielectric material 1212. The plug connector 1200 of FIG. 1b is similar to the TRRS type plug connector shown in FIG. 1a in that it also includes four ring-shaped connection areas 1210. However, the ring-shaped connection areas 1210 of the plug connector 1200 of FIG. 1b are not exposed on the outside and, hence, do not allow for an electrical connection to a conventional TRRS type socket connector (not shown).

Accordingly, in the mated state, the at least one connecting element 1120 of the socket connector 1100 does not establish an electrical connection with a corresponding connection area 1210 of the second type plug connector 1200. Instead, the connecting element 1120 of the socket connector 1100 allows for a capacitive connection with the corresponding connection area 1210 of the second type plug connector 1200.

In particular, the contact portion of the connecting element 1120 touches the dielectric material 1212 on the outside of the second type plug connector 1200. In other words, the dielectric material 1212 on the outside of the second type plug connector 1200 prevents, in the mated state, an electrical connection from establishing between the connecting element 1120 of the socket connector 1100 and the connection area 1210 of the second type plug connector 1200.

Each of the at least one connecting element 1120 additionally includes a non-contact portion which is arranged so that the surface thereof, in the mated state, covers at least parts of a connection area 1210 of the second type plug connector 1200. In other words, the non-contact portion of a connecting element 1120 is shaped so that it overlies at least parts of a corresponding connection area 1210 of the second type plug connector 1200.

Due to the surface area of the non-contact portion 1120 overlying and/or being arranged at close distance to the at least partly covered connection area 1210 of the second type plug connector 1200, a capacitive connection is established in the mated state between socket connector 1100 and a second type plug connector 1200. In other words, the more surface of a corresponding connection area 1210 of a second type plug connector 1200 is covered by the non-contact portion of the connecting element 1120, the higher the capacitive coupling between the connecting element 1120 of the socket connector 1100 and the connection area 1210 of the second type plug connector 1200.

In FIG. 1b, the surface of the non-contact portion of each of the connecting elements is laterally aligned with a corresponding connection area 1210 of the second type plug connector 1200. In particular, since the second type plug connector 1200 includes ring-shaped connection areas 1210, the non-contact portion of each of the connecting element 1120 is arranged in the housing of the socket connector so as to embrace the respective connection area 1210 from at least two sides.

Further, the non-contact portion of at least one connecting element 1120 may be arranged in the housing so as to have a predefined distance from the respective connection area 1210 of the second type plug connector 1200. Specifically, the non-contact portions illustrated in FIG. 1b above and below a connecting area 1210 of the second type plug connector 1200 belong to a same connecting element 1120 and are spaced from the surface of the respective connecting area 1210 in a predefined distance.

The capacitive coupling between the connecting element 1120 and the corresponding connection area 1210 allows for a capacitive connection between the socket connector 1100 and the second type plug connector 1200.

As described with respect to FIGS. 1a and 1b, the socket connector 1100 allows for an electrical connection with a first type plug connector 1200 and for a capacitive connection with a second type plug connector 1200. Accordingly, depending on the type of plug connector 1200 used, the socket connector enables the transmission and/or reception of data via two different connections, namely an electric connection or a capacitive connection.

Alternatively, an electrical connection with a first type plug connector 1200 may also be used for power transmission between the socket connector 1100 and the plug connector 1200. Depending on a need for power by the plug connector (or an attached appliance), the socket connector may, for instance, utilize the electrical connection to transmit power from the socket connector 1100 to the plug connector 1100.

According to a further, more detailed embodiment, the socket connector 1100 includes a detection circuit for enabling the socket connector 1100 to detect mating with a first type plug connector 1200 or a second type plug connector. In particular, the detection circuit is connected to at least two connecting elements 1120. When detecting, for instance, a pre-determined resistance between two connecting elements 1120, the detection circuit may determine that a first type plug connector is mated with the socket connector 1100. When detecting, for instance, a pre-determined capacitance between two connecting elements 1120, the detection circuit may determine that a second type plug connector is mated with the socket connector 1100.

Optionally, the detection circuit may be adapted to detect different pre-defined resistance or different pre-defined capacitance values (or ranges) for the socket connector to perform associated functionalities. For instance, upon the detection circuit of the socket connector 1100 detecting a first pre-determined resistance value (or range) between two connecting elements 1120, the socket connector may be configured to enable a data transmission via the connecting elements 1120 with the mated plug connector. Upon the detection circuit of the socket connector 1100 detecting a second pre-determined resistance value (or range), the socket connector may be configured to enable a power transmission via the connecting elements 1120 with the mated plug connector. Similarly, the detection of different pre-defined capacitance values (or ranges) may trigger reconfiguration of a functionality of the socket connector.

According to a more detailed embodiment, the at least one connecting element 1120 of the socket connector 1100 is connected to a transmission and/or reception circuit. The transmission and/or reception circuit is configured to process data input signals form input terminals so as to allow for an electrical or capacitive transmission and/or configured to receive an electrically or capacitively transmitted signal from a plug connector for supply to an output terminal.

For transmission via the capacitive connection, the transmission and/or reception circuit may adapt the frequency characteristic of data input signals so as to avoid transmission at low frequencies. In particular, the transmission and/or reception circuit may perform a modulation and/or demodulation operation wherein the baseband data input signal is modulated and/or a received data signal is demodulated with a predetermined carrier frequency.

The carrier frequency for the transmission between the socket connector 1100 and the plug connector 1200 is determined so that the capacitive connection does not affect the transmission characteristic. In particular, the capacitive connection has a characteristic of a high-pass filter on signal transmissions. Thus, a modulation and/or demodulation operation may shift the signal spectrum to/from a pass-band of the transfer function of the capacitive connection between the socket connector 1100 and a corresponding plug connector 1200.

According to a further, more detailed embodiment, the transmission and/or reception circuit may include the detection circuit to detect if a first type plug connector 1200 or a second type plug connector 1200 is mated with the socket connector. Upon detection of the mating of a first type plug connector 1200, the transmission and/or reception circuit in the socket connector may be configured to transmit and/or receive a baseband data signal to/from the first type plug connector. Further, upon the detection of the mating of a second type plug connector 1200, the transmission and/or reception circuit in the socket connector may be configured to transmit and/or receive a modulated data signal with a predetermined carrier frequency form the second type plug connector. Accordingly, the transmission and/or reception circuit of the socket connector 1100 operates differently for the first and second type plug connector 1200.

The socket connector 1100 may be utilized for data connections complying with known transmission standards, for instance, Ethernet, USB, CAN, IO-link and RS485 but also DVI, HDMI, mini DISPLAYPORT, micro USB 3.0 MHL and Thunderbolt.

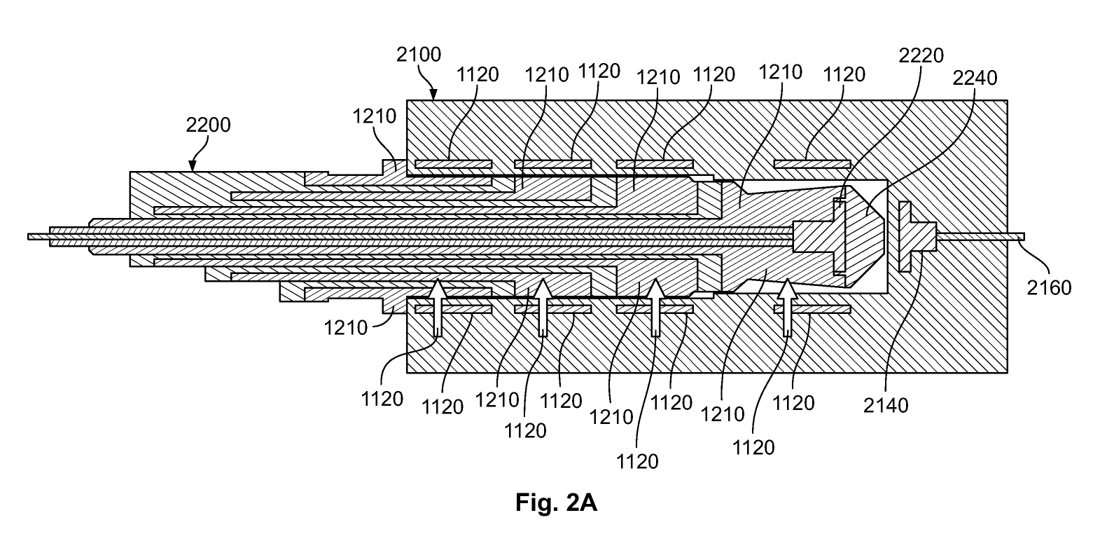

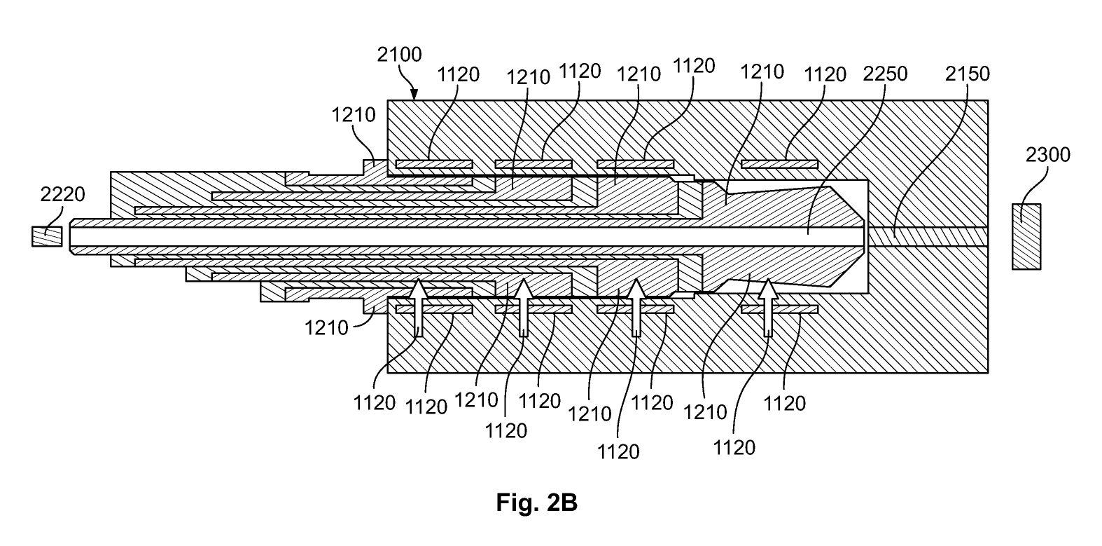

Referring now to FIGS. 2a and 2b, two exemplary implementations of a backward compatible socket connector according to a second embodiment of the invention are shown. The socket connector 2100 of FIGS. 2a and 2b is based on socket connector 1100 of FIGS. 1a and 1b. Corresponding parts are given corresponding reference numerals and terms and have been omitted from the description of the corresponding embodiment.

In the second exemplary embodiment of the invention, the socket connector 1100 of FIGS. 1a and 1b is enhanced by additionally enabling an electromagnetic connection between a plug connector and the socket connector. Thereby, two parallel communication paths are provided between the socket connector 2100 and the respective plug connector 2200 allowing for high data rates. For simplicity reasons, the electrical/capacitive connection is described as being independent from the additional electromagnetic connection. However, electromagnetic transmissions may interfere with the capacitive connection so that the respective transmission may require adaptation for reduction of the interference (e.g. by selection of a predetermined, different carrier frequency, by adjustment of the transmit power for the electromagnetic connection, or by usage of a adjusted data rate).

In FIGS. 2a and 2b, the socket connector 2100, according to the second exemplary embodiment, includes at least one connecting element 1120 which allows for an electrical connection with a first type plug connector 2200 and for a capacitive connection with a second type plug connector 2200. Additionally, the socket connector 2100 allows for an electromagnetic connection to plug connector via antenna element 2140 or 2300 capable of transmitting and/or receiving electromagnetic radio waves. The two exemplary implementations of the socket connector 2100 of FIGS. 2a and 2b differ in the manner of realizing the electromagnetic connection between the socket connector 2100 and the plug connector 2200.

As shown in FIG. 2a, according to a first exemplary implementation of the socket connector of the second embodiment, the housing of the socket connector 2100 includes antenna element 2140. The antenna element 2140 may be connected via micro coax cable to a transmission and/or reception circuit. The transmission and/or reception circuit may be included within the housing of the socket connector 2100 utilizing MID/LDS technology or may be integrated within a transceiver module incorporated within the housing.

In general, it is preferable to minimize the length of the micro coax cable between the antenna element and the transmitter and/or receiver circuit.

In the exemplary implementation shown in FIG. 2a, the antenna element 2140 is arranged in the rear wall portion of the cavity of the housing receiving a plug connector 2200. Accordingly, in relation to a mated plug connector, the antenna element 2140 is positioned within the housing so that the antennal element 2140 is arranged in the vicinity of the mating end of the mated plug connector, i.e. of its tip portion.

In FIG. 2a, the plug connector is shown as a first type plug connector 2200 including an antenna element 2220 arranged at the mating end of the first type plug connector 2200. The socket connector shown in FIG. 2a, also allows for mating with a second type plug connector 1200 including an antenna element arranged in the mating end thereof.

Irrespective of the type of the plug connector, an antenna element 2220 arranged at the mating end of a plug connector, in the mated state, enables an electromagnetic connection with the antenna element 2220 located in the vicinity of the rear wall of the socket connector 2100.

For an improved robustness, the antenna element 2200 is covered with dielectric material 2240 allowing at the same time for a reduced attenuating effect. Further, the dielectric material 2240 may also be used as a spacer for keeping the antenna element 2140 housed in the socket connector 2100 at a predefined distance to the antenna element 2220 of the plug connector 2200.

In the exemplary implementation shown in FIG. 2b, the socket connector 2100 includes a radio wave propagating element 2150 arranged in the rear wall portion of the cavity of the housing receiving a plug connector 2200. Accordingly, in relation to a mated plug connector, the radio wave propagating element 2150 is positioned within the housing so that the radio wave propagating element 2150 is arranged in the vicinity of the mating end of the mated plug connector, i.e. of its tip portion. The radio wave propagating element 2150 enables propagation of radio waves of the electromagnetic connection between socket connector 2100 and plug connector 2200 at low attenuation.

For instance, the radio wave propagating element 2150 may be formed as cylindrical opening allowing for a preferably undistorted propagation of radio waves for the electromagnetic connection between the plug connector and the socket connector. The cylindrical opening may be arranged in the direct line (i.e. line of sight) between the portion of the plug connector for emitting/receiving radio waves (e.g. the antenna element) and a position of an antenna element within or aside the socket connector 2100.

In FIG. 2b, an antenna element 2300 is provided behind the socket connector 2100. This arrangement may be preferable, in case the dimensions of the socket connector, the size of antenna element and/or the number of data input and data output terminals does not allow for integration within the socket connector. In this case, the antenna element 2300 may be arranged on a printed circuit board (PCB) in the vicinity of the socket connector, specifically at the back side the housing of the socket connector with respect to the opening of the socket connector. The antenna element 2300 is arranged in alignment with the mating portion of the plug connector.

Alternatively, the antenna element 2300 may be arranged on a PCB in the vicinity of the socket connector, sideward to the housing of the socket connector with respect to the opening of the socket connector. In this case the antenna element 2300 is not aligned with the mating portion of the plug connector. For this purpose, the radio wave propagating element 2150 of the socket connector 2100 may be arranged in an L-shape where the bent of the radio wave propagating element 2150 guides the electromagnetic transmission towards the antenna element 2300.

For a mechanically more robust implementation of the socket connector 2100, the radio wave propagating element 2150 may be provided of dielectric material allowing the propagation of radio waves with low attenuation. For dielectric material, for example resin, plastic or rubber may be used. Utilizing dielectric material for radio wave propagating element 2150, the socket element 2100 also protects from intrusion of liquids and shields a device interior from other environmental influences, link dust and dirt.

In FIG. 2b, the plug connector is shown as a first type plug connector 2200 including an antenna element 2220 and a waveguide 2250, the waveguide 2250 being arranged to propagate radio waves between the mating end of the first type plug connector 2200 and the antenna element 2220. The socket connector 2100 shown in FIG. 2b, also allows for mating with a second type plug connector 1200 including an antenna element together with a waveguide.

Irrespective of the type of the plug connector, an antenna element 2220 in combination with waveguide 2250 of a plug connector, in the mated state, enables an electromagnetic connection with the antenna element 2300 located in the vicinity of the rear wall of the socket connector 2100.

Although the description of the plug connector and the socket connector of the first and second embodiment supposes bi-directional data connections between the plug connector and the socket connector, the socket connector and the plug connector may also be configured to only provide for a unidirectional data connection. In this respect and according to another embodiment of the invention, a plug connector is configured only with a transmission circuit whereas the socket connector is configured only with a reception circuit. Such a plug connector and socket connector may be advantageous in view of time critical transmissions, highly fail safe appliances or cost optimization reasons.

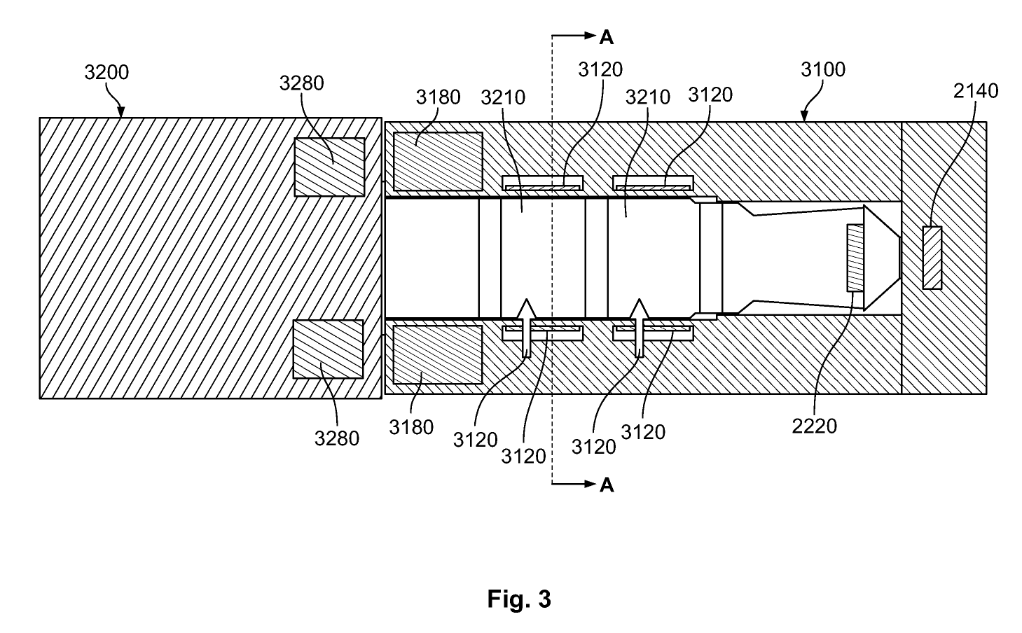

Referring now to FIG. 3, a third exemplary embodiment of a backward compatible socket connector according to the invention is shown. The socket connector 3100 of FIG. 3 is based on socket connector 2100 of FIGS. 2a and 2b and socket connector 1100 of FIGS. 1a and 1b. Corresponding parts are given corresponding reference numerals and terms and have been omitted from the description of the corresponding embodiment.

In FIG. 3, the socket connector 3100 includes at least one connecting element 3120 which allows for an electrical connection with a first type plug connector 3200 and for a capacitive connection with a second type plug connector 3200.

The connecting element 3120 basically corresponds to the connecting element 1210. The connecting element 3120 also includes a contact portion for contacting a connection area of the first type plug connector (indicated by the arrow in FIG. 3) and a non-contact portion which is arranged to cover at least parts of a connection area 3210 of a second type plug connector. The connecting element 3120 differs from the connecting element 1210 in that it is mounted flexibly within the housing of the socket connector 3100.

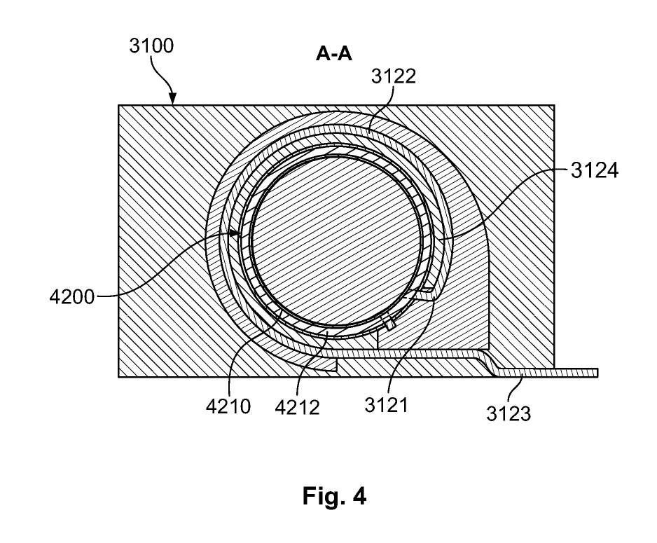

The connecting element 3120 is described in detail with reference to FIG. 4 which shows the connecting element 3120 in a cross-section view along the line A-A.

The socket connector 3100 of the third exemplary embodiment, further includes an antenna element 2140 arranged in the rear wall portion of the cavity for receiving a plug connector 3200 within the housing. Accordingly, in relation to a mated plug connector, the antenna element 2140 is positioned in the housing so that the antenna element 2140 is arranged in the vicinity of the mating end of a mated plug connector wherein, for instance, the plug connector includes a corresponding antenna element 2240 within its tip portion.

In FIG. 3, the plug connector is shown as a first type plug connector 2200 including an antenna element 2220 arranged in the mating end of the first type plug connector 2200. The socket connector 3200 of the third embodiment, however, also allows for mating with a second type plug connector 1200 including an antenna element arranged so as to emit/receive radio waves at the mating end thereof.

Irrespective of the type of the plug connector, the antenna element 2220 is arranged in the plug connector so that, in the mated state, the antenna element 2220 emits/receives radio waves in/from a direction of the rear wall of the socket connector 3100.

Further, the socket connector 3100 of the third exemplary embodiment allows for transmission of power between socket connector 3100 and plug connector 3200. For this purpose, the socket connector 3100 and plug connector 3200 include inductive coupling elements 3180, 3280.

Accordingly, the system of the socket connector 3100 and the plug connector 3200 according to the third exemplary embodiment of FIG. 3 realizes a full-featured data and power connection and is compatible with known transmission standards, for instance, Ethernet, USB, CAN IO-link and RS485 but also DVI, HDMI, mini DISPLAYPORT, micro USB 3.0 MHL and Thunderbolt.

For transmission of power, the socket connector 3100 of FIG. 3 includes an inductive coupling element 3180, the inductive coupling element 3180 being provided within the housing at the rim portion of the cavity for receiving the plug connector 3100. In other words, the inductive coupling element 3180 is arranged within the housing around the opening of the cavity for receiving the plug connector 3200. The inductive coupling element 3180 is located at a predetermined distance from the at least one connecting element 3120 to reduce an interference and other disadvantageous effects.

In FIG. 3, the mated plug connector 3200 also includes an inductive coupling element 3280, wherein the inductive coupling element 3280 is arranged so as to allow, in the mated state, for a high power transmission ratio with the inductive coupling element 3180.

Although not shown, the socket connector 3100 may additionally include an intermediate voltage regulator connected to the inductive coupling element 3180. The intermediate voltage regulator may convert a supplied voltage level to a predefined voltage level which is advantageous for transmission via the inductive coupling element 3180. Additionally or alternatively, the intermediate voltage regulator may include a DC/AC converter for converting a DC input voltage from the power terminal to an AC output voltage so as to allow transmission via the inductive coupling element 3180.

Similarly, the corresponding plug connector 3200 may also include an intermediate voltage regulator connected to the inductive coupling element 3280. The voltage regulator of the corresponding mating connector 3280 is configured inverse to the voltage regulator of the socket connector 3100.

For reduction of transmission losses between the socket connector 3100 of the third embodiment and the corresponding plug connector 3200, the inductive coupling element 3180 of the socket connector 3100 and the corresponding inductive coupling element 3280 of the plug connector 3200 are incorporated in the respective housings in alignment to each other. In particular, the inductive coupling element 3180 is arranged in the housing of the socket connector 3100 so that it forms, in the mated state, an resonance loop with the corresponding inductive coupling element 3280 of the plug connector 3200.

Referring now to FIG. 4, the backward compatible socket connector of the third exemplary embodiment of the invention is shown in a cross-section view. The socket connector 3100 of FIG. 4 illustrates a cross-section view of the socket connector 3100 of FIG. 3, namely along the line A-A indicated in FIG. 3.

Accordingly, the socket connector 3100 of FIG. 4 is based on socket connector 2100 of FIGS. 2a and 2b and socket connector 1100 of FIGS. 1a and 1b. Corresponding parts are given corresponding reference numerals and terms and have been omitted from the description of the corresponding embodiment.

In FIG. 4, the connecting element 3120 according to the third exemplary embodiment is shown in a cross-section view. The connecting element 3120 is arranged within the housing of the socket connector 3100. The connecting element 3120 includes a contact portion 3121 for contacting a connection area of a first type plug connector.

The connecting element 3120 further includes a non-contact portion 3122 which is arranged so that the surface thereof covers at least parts of a connection area of the second type plug connector. In other words, the non-contact portion 3122 of the connecting element 3120 is formed in a shape so that it overlies at least parts of a connection area of the second type plug connector.

The connecting element 3120 according to the third exemplary embodiment is realized with a circular cross section and is illustrated in FIG. 4 as a spring in a non-flexed state. The circular cross section of the connecting element 3120 has a slightly larger diameter than the round mating end of the first type and of the second type plug connector.

In more detail, the contact portion 3121 and the non-contact portion 3122 of the connecting element 3120 of the third exemplary embodiment are realized of a same conductive material, for instance, metal namely copper or steel.

The connecting element 3120 of the third exemplary embodiment touches a mated plug connector with the contact portion 3121 and, in case of mating with a first type plug connector, thereby realizes an electric connection between the contact portion 3121 of the connecting element 3120 and a corresponding connection area of the first type plug connector. Accordingly, upon mating with a first type plug connector, a current may flow from the first type plug connector, via the contact portion 3121 of the connecting element 3120, and via the non-contact portion 3122 of the connecting element 3120 to the socket connector 3100 and vice versa.

In other words, the non-contact portion 3122 is utilized as an electrical connection for supply of current to/from the contact portion 3121 of the connecting element 3120. The non-contact portion 3122 of the connecting element 3120 within the socket connector 3100 may be considered a passive component in combination with a first type plug connector.

When mating with a second type plug connector, the contact portion 3121 of the connecting element 3120 still touches the outside of a mated second type plug connector, yet, no electric connection is realized. Due to dielectric material covering the connection area of a second type plug connector, the contact portion 3121 of the connecting element 3120 does not allow for an electric connection between socket connector 3100 and the second type plug connector 3200.

Further, in the mated state with a second type plug connector, the non-contact portion 3122 of the connecting element 3120 according to the third exemplary embodiment provides for a capacitive connection between the socket connector 3100 and the plug connector. In particular, the non-contact portion 3122 of the connecting element 3120 according to the third exemplary embodiment is arranged so that it at least partially surrounds the cavity for receiving a plug connector. In particular, in the mated state with a second type plug connector, the non-contact portion 3122 of the connecting element 3120 surrounds a connection area 3210 of the second type plug connector 4200.

Due to the surface area of the non-contact portion 3120 overlying and being arranged at close distance to the at least partly surrounded connection area 4210 of the second type plug connector 4200, a capacitive connection is established in the mated state between socket connector 3100 and the second type plug connector 4200. The second type plug connector 4200 of FIG. 4 includes a dielectric material 4212 covering the connection area 4210 on the outside.

The connecting element 3120 further includes a terminal portion 3123 for connection to a transmission and/or reception circuit. The terminal portion 3123 is realized of the same conductive material as the contact portion 3121 and the non-contact portion 3122 of the connecting element 3120 of the third exemplary embodiment.

The socket connector 3100 of the third exemplary embodiment further includes dielectric material 3124 provided on the surface of the non-contact portion 3122 of the connecting element 3120 between the non-contact portion 3122 of the connecting element 3120 and a connection area 4210 of a mated second type plug connector 4200. By providing a dielectric material 3124 with a high permittivity, the capacitive coupling between the non-contact portion 3122 of the connecting element 3120 and the connection area 4210 of the second type plug connector 4200 improves.

Additionally, the dielectric material may be arranged to allow for an equidistant spacing between the surface of the mating end of the second type plug connector and non-contact portion 3122 of the connecting element 3120 also improving the capacitive coupling between the connecting element 3120 socket connector 3100 and the second type plug connector 4200.

Further, since the first type plug connector 1200 and the second type plug connector 1200 use an approximately same lateral segmentation for the connection areas (i.e. approximately same width of and same distance between corresponding connection areas), the non-contact portion 3122 is laterally aligned with a respective connection area 4210.

### REFERENCE NUMERALS

| Reference Numerals | Description |
|---|---|
| 1100, 2100, 3100, 5100 | socket connector |
| 1120, 3120, 5120 | connecting element |
| 3121 | contact portion |
| 3122 | non-contact portion |
| 3123 | terminal portion |
| 3124 | dielectric material |
| 2140 | antenna element |
| 2150 | radio wave propagating element |
| 2160 | micro coax cable |
| 3180 | inductive coupling element |
| 1200, 2200, 3200, 5200 | plug connector |
| 1210, 2210, 3210, 4210, 5210 | connection area |
| 4212 | dielectric material |
| 2220, 2300 | antenna element |
| 2240 | dielectric material |
| 2250 | Waveguide |
| 2260 | micro coax cable |
| 3280 | inductive coupling element |

1. Socket connector for electrically connecting a first corresponding mating plug connector and for capacitively connecting a second corresponding mating plug connector, the socket connector comprising:
a housing with a cavity for receiving either of the first and second plug connector; and at least one connecting element arranged within the housing, and including a contact portion for contacting a connection area of the first plug connector, and a non-contact portion arranged such that, in the mated state, the surface thereof covers at least parts of a connection area of the second plug connector.

2. The socket connector according to claim 1, wherein the contact portion and the non-contact portion of the connecting element are provided of a same conductive material.

3. The socket connector according to claim 1, wherein, in the mated state, the surface of the non-contact portion, covering the connection area of the second plug connector, is provided at a predefined distance to the connection area of the second plug connector.

4. The socket connector according to claim 1, wherein the at least one connecting element is arranged within the housing so as to at least partially surround the cavity thereof.

5. The socket connector according to claim 1, wherein the at least one connecting element is arranged within the housing so as to surround the cavity in a direction perpendicular to the longitudinal axis defined by the mating movement with the first or second plug connector.

6. The socket connector according to claim 1, further comprising a dielectric material provided on the surface of the non-contact portion of the at least one connecting element so as to be arranged, in the mated state, between the non-contact portion of the connecting element and the connection area of the second plug connector.

7. The socket connector according to claim 1, wherein for a circular/rectangular/oval second plug connector, the at least one connecting element is arranged with a circular/rectangular/oval cross section.

8. The socket connector according to claim 1, further comprising a transmission and/or reception circuit connected to the at least one connecting element for transmitting and/or receiving data or power via an electrical connection, and for transmitting and/or receiving data via an capacitive connection to/from the mated first or second plug connector.

9. The socket connector according to claim 1, further comprising an antenna element provided within the rear wall portion of the housing so as to be arranged in the vicinity of a tip portion of a mated first or second plug connector, wherein the antenna element is connected to a transmission and/or reception circuit for receiving data via an electromagnetic connection from the respective first or second plug connector; or a capacitive plate provided within the rear wall portion of the housing so as to be arranged in the vicinity of a tip portion of a mated first or second plug connector, wherein the capacitive plate is connected to a transmission and/or reception circuit for receiving data from the respective first or second plug connector.

10. The socket connector according to claim 1, further comprising a radio wave propagating element provided within the rear wall portion of the housing so as to allow propagation of radio waves for an electromagnetic connection between an antenna element within the mated first or second plug connector and an antenna element provided behind the socket connector.

11. The socket connector according to claim 1, further comprising an inductive coupling element provided within the housing at a rim portion of the cavity wherein the inductive coupling element is arranged so as to form in the mated state an induction loop with a corresponding inductive coupling element of a first or second plug connector.

12. The socket connector according to claim 1, wherein the housing is adapted to receive a 3-pole tip-ring-sleeve (TRS) type first plug connector, such that a first of the at least one connecting element is aligned with a lateral tip connection area of the first plug connector, a second of the at least one connecting element is aligned with a ring connection area of the first plug connector, and a third of the at least one connecting element is aligned with a sleeve connection area of the first plug connector; and/or wherein the housing is adapted to receive a 4-pole tip-ring-ring-sleeve (TRRS) type first plug connector, and a first of the at least one connecting element is aligned with a lateral tip connection area of the first plug connector, a second of the at least one connecting element is aligned with a ring connection area of the first plug connector, a third of the at least one connecting element is aligned with another ring connection area of the first plug connector, and a fourth of the at least one connecting element is aligned with a sleeve connection area of the first plug connector.

13. The socket connector according to claim 1, wherein the housing is sealed against intrusion of water and/or wherein the housing of the socket connector is arranged to receive a radial first or second plug connector allowing the plug connector to rotate in a mated state.

14. Socket connector system comprising a socket connector according to claim 1, and a corresponding 3-pole tip-ring-sleeve (TRS) type first plug connector or a corresponding O-pole tip-ring-ring-sleeve (TRRS) type first plug connector.

15. Socket connector system comprising a socket connector according to claim 1, and a corresponding second plug connector with at least one connection area covered on the outside with dielectric material, wherein, in a mated state, a capacitive connection is made available between the at least one connecting element of the socket connector and the respective one of the at least one connection area of the corresponding second plug connector.
